(19) United States
(12) Patent Application Publication
(10) Pub. No.: US 2025/0227737 A1
(43) Pub. Date: Jul. 10, 2025

(54) PHYSICAL SIDELINK FEEDBACK CHANNEL (PSFCH) AND SYNCHRONIZATION CHANNELS FOR A SIDELINK SYSTEM OPERATING IN AN UNLICENSED BAND

(71) Applicant: Intel Corporation, Santa Clara, CA (US)

(72) Inventors: Salvatore Talarico, Santa Clara, CA (US); Kilian Roth, Munich (DE); Alexey Khoryaev, Santa Clara, CA (US); Sergey Panteleev, Kildare (IE); Mikhail Shilov, Santa Clara, CA (US)

(21) Appl. No.: 18/833,820

(22) PCT Filed: Apr. 21, 2023
(86) PCT No.: PCT/US2023/066051

§ 371 Date: Jul. 26, 2024

Related U.S. Application Data
(60) Provisional application No. 63/333,984, filed on Apr. 22, 2022.
(60) Provisional application No. 63/355,965, filed on Jun. 27, 2022.
(60) Provisional application No. 63/407,422, filed on Sep. 16, 2022.

(51) Int. Cl. H04W 72/40

(52) U.S. Cl. CPC H04W 72/40

(57) ABSTRACT

Various embodiments herein provide techniques for sidelink (SL) communication on unlicensed spectrum. For example, embodiments provide techniques for a physical sidelink feedback channel (PSFCH) and/or a SL synchronization signal block (S-SSB), such as techniques related to a listen-before-talk (LBT) procedure and/or occupied channel bandwidth (OCB) requirements. Other embodiments may be described and claimed.

### CROSS REFERENCE TO RELATED APPLICATION

The present application claims priority to U.S. Provisional Patent Application No. 63/333,984, which was filed Apr. 22, 2022; U.S. Provisional Patent Application No. 63/355,965, which was filed Jun. 27, 2022; and to U.S. Provisional Patent Application No. 63/407,422, which was filed Sep. 16, 2022.

### FIELD

Various embodiments generally may relate to the field of wireless communications. For example, some embodiments may relate to sidelink communications, e.g., in unlicensed spectrum.

### BACKGROUND

Mobile communication has evolved significantly from early voice systems to today's highly sophisticated integrated communication platform. The next generation wireless communication system, fifth generation (5G) (which may be additionally or alternatively referred to as new radio (NR)) may provide access to information and sharing of data anywhere, anytime by various users and applications. NR may be a unified network/system that target to meet vastly different and sometime conflicting performance dimensions and services. Such diverse multi-dimensional requirements may be driven by different services and applications.

For instance, in the third generation partnership project (3GPP) release-16 (Rel.16) specifications, sidelink (SL) communication was developed in radio access network (RAN) to support advanced vehicle-to-anything (V2X) applications. In release-17 (Rel.17), SA2 studied and standardized proximity based service including public safety and commercial related services and as part of Rel.17, power saving solutions (e.g., partial sensing, discontinuous reception (DRX), etc.) and inter-user equipment (UE) coordination have been developed to improve power consumption for battery limited terminals and reliability of SL transmissions. Although NR SL was initially developed for V2X applications, there is growing interest in the industry to expand the applicability of NR SL to commercial use cases, such as sensor information (e.g., video) sharing between vehicles with high degree of driving automation. For commercial SL applications, desirable features may include increased SL data rate and support of new carrier frequencies for SL. To achieve these elements, one objective in release-18 (Rel.18) is to extend SL operation in unlicensed spectrum (e.g., referred to as NR-U SL).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates New Radio-Unlicensed (NR-U) sidelink (SL) communication modes.

FIG. 2 illustrates an example of a discovery reference signal (DRS) transmission with a duration of 1 ms and a subcarrier spacing (SCS) of 30 KHz.

FIG. 3 illustrates an example of cyclic shift hopping for a physical sidelink feedback channel (PSFCH) transmission with more than one physical resource block (PRB), in accordance with various embodiments.

FIG. 4 illustrates an example of one-to-many mapping between a physical sidelink control channel (PSCCH) or physical sidelink shared channel (PSSCH) transmission resource and PSFCH resource occasions, in accordance with various embodiments.

FIG. 5 illustrates an example physical structure of a sidelink synchronization signal block (S-SSB), e.g., including a physical sidelink broadcast channel (PSBCH), a sidelink primary synchronization signal (S-PSS), and a sidelink secondary synchronization signal (S-SSS), in accordance with various embodiments.

FIGS. 6A-6C illustrate example enhancements of the S-SSB by mapping PSBCH in the upper resource blocks (RBs) (FIG. 6A), the lower RBs (FIG. 6B), or around the legacy S-PSS and S-SSS (FIG. 6C) of a listen-before-talk (LBT) bandwidth (BW) to cumulatively occupy 20 MHz without the automatic gain control (AGC) symbol, in accordance with various embodiments.

FIG. 7 illustrates an example enhancement of the S-SSB by repeating PSBCH around the legacy S-PSS and S-SSS to cumulatively occupy 20 MHz, in accordance with various embodiments.

FIG. 8 illustrates an example enhancement of the S-SSB by repeating PSBCH around the legacy S-PSS and S-SSS to cumulatively occupy 20 MHz, in accordance with various embodiments.

FIGS. 9A-9D illustrate different options to fulfill occupied channel bandwidth (OCB) requirements for S-SSB when operating in unlicensed spectrum, in accordance with various embodiments. For example, FIG. 9A illustrates the case when the legacy S-SSB may be rate matched/enhanced over 20 MHz. FIG. 9B illustrates the case when legacy S-SSB is repeated over time to span over the whole 20 MHz band. FIG. 9C illustrates the case when legacy S-SSB is multiplexed with other SL signals/channels to span over 20 MHz. FIG. 9D illustrates the case when the legacy S-SSB is mapped over a specific comb structure, where the elements composing the structure can be at the resource element (RE), RB, or group of RBs level.

FIG. 10 illustrates an example enhancement of the S-SSB by mapping PSBCH over 12 PRBs and around S-PSS and S-SSS when the system operates at 15 KHz SCS, in accordance with various embodiments.

FIG. 11 illustrates an example of an S-SSB transmission opportunity window which allows four S-SSB occasions, where the pre-configured S-SSB resource is aligned with the start of the window, in accordance with various embodiments.

FIG. 12 schematically illustrates a wireless network in accordance with various embodiments.

FIG. 13 schematically illustrates components of a wireless network in accordance with various embodiments.

FIG. 14 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 15, 16, and 17 illustrate example procedures to practice the various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein provide techniques for sidelink (SL) communication on unlicensed spectrum. For example, embodiments provide techniques for a physical sidelink feedback channel (PSFCH) and/or a SL synchronization signal block (S-SSB), such as techniques related to a listen-before-talk (LBT) procedure and/or occupied channel bandwidth (OCB) requirements.

As discussed above, one of the key objectives in Rel.18 is to extend SL operation in unlicensed spectrum (NR-U SL). However, note that to allow fair usage of the spectrum and fair coexistence among different technologies, different regional regulatory requirements are imposed worldwide. Thus, to enable a solution for all regions complying with the strictest regulation from ETSI BRAN published in EN 301 893 may be sufficient. For the development of NR-U during Rel. 16 a 3GPP NR based system complying with these regulations was developed.

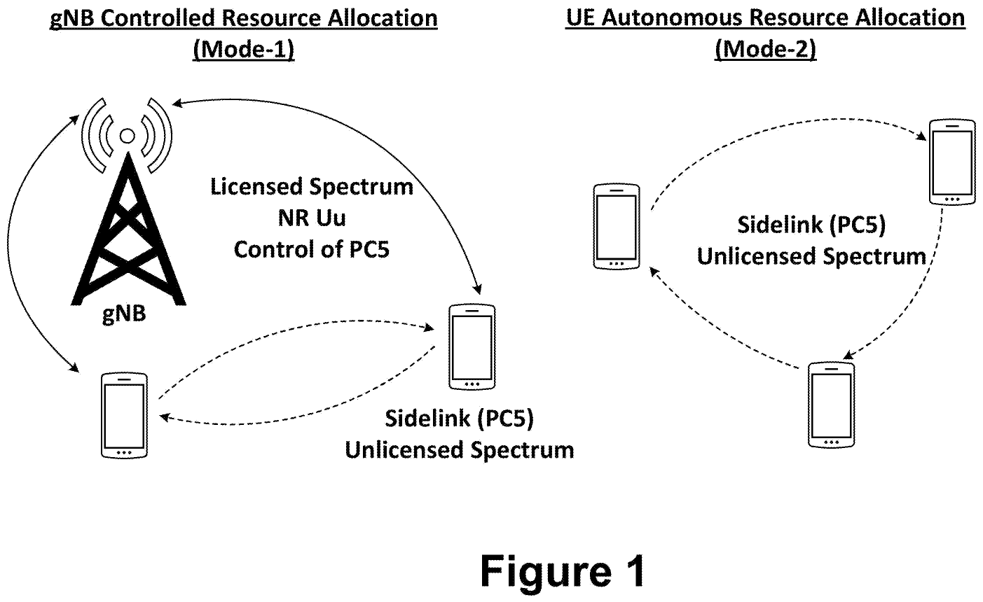

With that said, given that the target is to enable a SL communication system in the unlicensed band, the considerations of SL communication systems need to be combined with the regulatory requirements necessary for the operation in the unlicensed bands. For example, NR SL may be operated through two modes of operation: 1) mode-1, where a gNB schedules the SL transmission resource(s) to be used by the UE, and Uu operation is limited to licensed spectrum only; 2) mode-2, where a UE determines (e.g, gNB does not schedule) the SL transmission resource(s) within SL resources which are configured by the gNB/network or pre-configured. FIG. 1 illustrates the two modes of operation.

In this context, there are several specific challenges to enable NR-U SL. In particular, one of the challenges is that when operating in the FR-1 unlicensed band a listen before talk (LBT) procedure needs to be performed to acquire the medium before a transmission can occur, which can potentially be performed at any time to significantly improve the overall system performance, requiring also a SL transmission to start soon after it, so that channel can be grabbed immediately. Another important feature when operating in unlicensed spectrum is that the acquired channel by a device can be shared with other devices (between the UE and the gNB) to allow a more efficient use of a channel occupancy time (COT). Furthermore, ETSI BRAN mandates at any time at least 80% of a nominal channel bandwidth should be occupied as specified through the following text:

| | |
|---|---|
| 4.2.2 | Nominal Channel Bandwidth and Occupied Channel Bandwidth |
| 4.2.1 | Definition |

The Nominal Channel Bandwidth is the widest band of frequencies, inclusive of guard
bands, assigned to a single channel.
The Occupied Channel Bandwidth is the bandwidth containing 99% of the power of
the signal.
When equipment has simultaneous transmission in adjacent channels, these
transmissions may be considered as one signal with an actual Nominal Channel
Bandwidth of “n” times the individual Nominal Channel Bandwidth where “n” is the
number of adjacent channels. When equipment has simultaneous transmissions in
non-adjacent channels, each power envelope shall be considered separately.

| | |
|---|---|
| 4.2.2.2 | Limits |

The Nominal Channel Bandwidth for a single Operating Channel shall be 20 MHz.
Alternatively, equipment may implement a lower Nominal Channel Bandwidth with
a minimum of 5 MHz, providing they still comply with the Nominal Centre
Frequencies defined in clause 4.2.1 (20 MHz raster).
The Occupied Channel Bandwidth shall be between 80% and 100% of the Nominal
Channel Bandwidth. In case of smart antenna systems (devices with multiple transmit
chains) each of the transmit chains shall meet this requirement. The Occupied
Channel Bandwidth might change with time/payload.
During a Channel Occupancy Time (COT), equipment may operate temporarily with
an Occupied Channel Bandwidth of less than 80% of its Nominal Channel Bandwidth
with a minimum of 2 MHz.

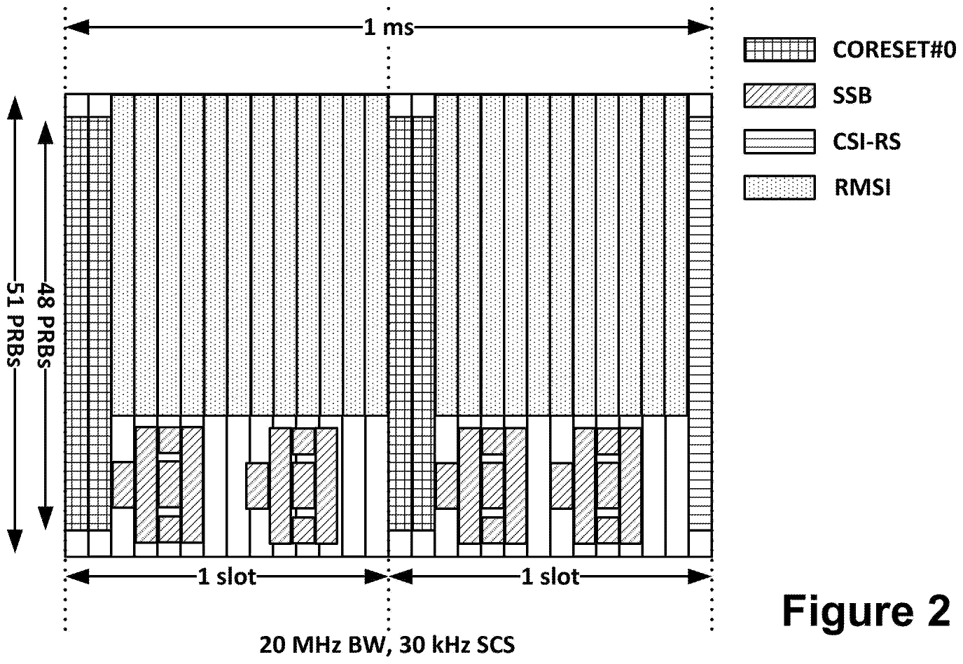

To fulfill these requirements, NR-U, licensed-assisted access (LAA) and MulteFire have adopted an interleaved PRB mapping, called interlaced mapping, which has been applied to PUCCH and PUSCH. More importantly, for the synchronization signals the concept of Discovery Reference Signal (DRS) has been formed, which comprises of SS/PBCH and optionally NZP CSI-RS, PDSCH for SIB1, and associated PDCCH. An example of the structure of the DRS for 30 kHz SCS is provided in FIG. 2.

Another important aspect to consider is that ETSI BRAN defines a specific class of signals, called short control signaling, which may be transmitted without any LBT or under specific LBT exceptions. A short control signal is a signal which is not transmitted more than 50 times within any observation windows of 50 ms, and within any observation windows its aggregated transmission may not exceed 2.5 ms, as described by the following text:

| | |
|---|---|
| 4.2.7.3.3 | Short Control Signalling Transmissions (FBE and LBE) |
| 4.2.7.3.3.1 | General |

Frame Based Equipment and Load Based Equipment are allowed to have Short Control
Signalling Transmissions on the Operating Channel providing these transmissions
comply with the requirements in clause 4.2.7.3.3. It is not required for adaptive
equipment to implement Short Control Signalling Transmissions.

| | |
|---|---|
| 4.2.7.3.3.2 | Definition |

Short Control Signalling Transmissions are transmissions used by the equipment to
send management and control frames without sensing the channel for the presence of
other signals.

| | |
|---|---|
| 4.2.7.3.3.2 | Limits |

The use of Short Control Signalling Transmissions in constrained as follows:

| | |
|---|---|
| • | within an observation period of 50 ms, the number of Short Control Signalling |
| | Transmissions by the equipment shall be equal to or less than 50; and |
| • | the total duration of the equipment's Short Control Signalling Transmissions |
| | shall be less than 2500 μs within said observation period. |

In this sense, in NR-U the DRS has been the only signal qualified as a short control signaling, and in this sense a gNB is allowed to transmit this type of signal by using type 2A channel access to acquire the channel, instead of using type 1 LBT.

On the other hand, the Rel.16 NR SL has been targeted only for operation in licensed spectrum, and was not designed having in mind that possible LBT failure could occurs. For instance, the starting time of the sidelink feedback channel (PSFCH) is always at the end of a slot, and the instance in time where this transmission is performed is deterministic, and occurs in a periodic manner: in fact, the presence of this signal can be configured to be every slot, every two slots or every four slots. Furthermore, for Re.16 NR SL, there is a very simple/direct mapping between the initial (re)-transmission and the PSFCH resources. However, when operating in unlicensed spectrum there are several aspects that should be considered in this matter: 1) the PSFCH may need to be able to provide HARQ feedback for multi-slot transmissions, since a UE to more optimally utilize a COT, and reduce LBT overhead may be allowed to perform long contiguous transmissions which go far behind a single SL slot; 2) the PSFCH may need to be designed having in mind that its transmission cannot occur in a deterministic manner, but it may be conditional to the related channel access procedure that must be performed to acquire the channel over which this transmission occurs; and 3) the PSFCH must meet the OCB requirements mandated by the ETSI BRAN. Various embodiments herein provide techniques for PSFCH, which may address the above considerations and/or other considerations.

Another aspect covered by this disclosure is related to the SL synchronization channels (e.g., S-SSB and/or PSBCH), which may also be designed based on the same criteria mentioned above for PSFCH. In Rel. 16 NR SL, the SL synchronization signals were designed such that their transmission occurs in a periodic manner, without any consideration on LBT failures and OCB requirements. Various embodiments herein further provide techniques for the SL synchronization signals, which may address the above considerations and/or other considerations.

When operating in unlicensed spectrum there are several aspects that should be considered when designing PSFCH: 1) the PSFCH may need to be able to provide HARQ feedback for multi-slot transmissions, since a UE to more optimally utilize a COT, and reduce LBT overhead may be allowed to perform long contiguous transmissions which go far beyond a single SL slot; 2) the PSFCH may need to be designed having in mind that its transmission cannot occur in a deterministic manner, but it may be conditional to the related channel access procedure that must be performed to acquire the channel over which this transmission occurs; and 3) the PSFCH must meet the OCB requirements mandated by the ETSI BRAN. Various embodiments herein provide techniques for PSFCH, which may address these considerations.

Furthermore, similar considerations may apply to the SL synchronization signals. In 3GPP Rel. 16 NR SL, the SL synchronization signals were designed such that their transmission occurs in a periodic manner, without any consideration on LBT failures and OCB requirements. Accordingly, embodiments herein also provide techniques for SL synchronization signals to enable them to operate in unlicensed spectrum (e.g., in Frequency Range 1 (FR-1)).

### Start/End Time of PSFCH Transmission

In one embodiment, gaps between PSSCH and PSFCH allocation can be reduced to avoid LBT procedure for PSFCH transmission (e.g., gaps can be reduced to T_{gap}≤16 us to apply LBT Type 2C) and thus avoid LBT procedure for PSFCH transmission. Furthermore, in one option, when the PSFCH occurs within a COT (either TX UE or any other UE), the PSFCH must span within the BW over which the initiating device of that COT has accessed the channel.

In another embodiment, when the PSFCH transmission occurs outside a COT shared by another device, it can use one of the following procedures:
Option 1: Any LBT type that is allowed based on the system state;
Option 2a: PSFCH transmission is qualified as short control signaling and type 2A LBT is used;
Option 2b: PSFCH transmission is qualified as short control signaling and type 2C LBT is used.

In case a PSFCH transmission is qualified as short control signaling, in one embodiment, regardless of whether Option 2a or 2b above is adopted, the 5% duty cycle is applied for device (e.g., regardless of whether it operates as initiating or responding device), meaning that the UE transmitting PSFCH will be responsible to meet the 5% duty cycle, otherwise type 1 LBT will be needed for any additional PSFCH transmission. In another option, regardless of whether Option 2A or 2b above is adopted, the 5% duty cycle is applied per “initiating” device, meaning the 5% is counted independently of the UE transmitting PSFCH by the UE that is initiating the COT. In other words, the UE only counts the aggregation time of all the channels that are qualified as short control signaling which are transmitted as if the UE is the initiating device, and it is left up to UE to be responsible to not exceed the 5% duty cycle and use type 1 LBT for any additional PSFCH transmission exceeding the 5% limit. In another option, regardless of whether Option 2A or 2b above is adopted, the 5% duty cycle is applied per “cell”, meaning the 5% is counted independently of the UE transmitting PSFCH by the serving gNB or by the UE for which the PSFCH is meant to, and it is left up to gNB's or that UE to indicate whether LBT or not LBT is needed, and which LBT to use.

In one embodiment, when the PSFCH transmission occurs outside a COT shared by another device, and the PSFCH may occur at the starting point of the COT (e.g., a PSFCH aligns with the start of a COT or a fixed frame period), the PSFCH is dropped.

In one embodiment, a new RRC parameter can be introduced, which may be either UE-specific or cell-specific, indicating whether a UE may or may not qualify a PSFCH as a short control signaling, or whether in general a UE may be allowed to qualify one or more of the following as a short control signaling:
PSFCH
PSBCH
S-SSB

### Number of PRBs for PSFCH Transmission

In order to meet the OCB requirements mandated by the ETSI BRAN, when PSFCH is used for SL systems operating in unlicensed spectrum, an interlaced mapping can be adopted. However, while in Rel.16 NR SL design, the PSFCH spans over a single PRB, in unlicensed operation this should span over a multitude of PRBs. In this sense, in one embodiment, PSFCH may follow an interlaced mapping or spanning over the whole LBT BW (e.g., in chucks of 20 MHz), or as an additional option it may span within an interlaced over a subset of the total available RBs. In one embodiment, to meet the OCB and PSD restrictions mandated by ETSI BRAN for PSFCH, an RB-based interlace is supported for 15 kHz and 30 kHz subcarrier spacing (SCS), while for 60 kHz the design could follow another embodiment described herein.

In one embodiment, the PSFCH spans over all REs of the RB sets over which the LBT was performed to acquire the COT within which the PSFCH is transmitted.

In a second embodiment, for an interlaced transmission all RBs related to interlaced group of RBs need to be used by the PSFCH. If interlaced sub-channel mapping is used this means it needs to span all RBs of one sub-channel.

In a third embodiment, for an interlaced transmission only some of the RBs related to the interlaced group of RBs is used by a PSFCH transmission.

In another embodiment, a PSFCH transmission may occupies a dedicated PRB within an interlace.

In another embodiment, a PSFCH transmission for each RX UE is sent in a dedicated RB belonging to an interlace, but to comply with the OCB and PSD restrictions, such feedback is repeated in a set of common RBs along the interlace that are used by other Rx UEs for the same purpose. In other words, the RBs belonging to an interlaced will be grouped in dedicated and common RBs: the dedicated RBs are used for individual PSFCH transmissions, while the common RBs are used for the only purpose of meeting the OCB/PSD restriction when needed. This won't necessarily mean that a PSFCH transmission will need to be repeated over all the RBs belonging to an interlace, but multiple PSFCH transmissions can be multiplexed in the same interlaced. As one alternative, while in the dedicated RBs UEs may transmit individually the PSFCH without overlapping with other UEs' resources, the common resources are used by the UEs only for the matter of meting the OCB and PSD restrictions, and PSFCH transmission from different UEs may overlap in the common resources, but as an option may be still orthogonalized using different OCC or generally in code domain.

In another embodiment, a PSFCH transmission for each RX UE is sent in a dedicated RB belonging to an interlace, but to comply with the OCB and PSD restrictions, such feedback is repeated within the RBs of a common interlace that is used by all other Rx UEs for the same purpose.

In one embodiment, a PSFCH transmission always falls within one or more RBs belonging to the interlace or interlaces used to transmit the corresponding PSCCH/PSSCH.

Since the aforementioned OCB requirement if not mandate worldwide, but only in specific regions, in one embodiment, an RRC parameter can be introduced to indicate to SL UEs when the PSFCH mapping should follow the interlaced mapping or spanning over the whole LBT BW.

Given that as mentioned above, when the OCB requirements mandated by the ETSI BRAN need to be met, PSFCH must span over a number of PRBs larger than 1, then in this case the sequence generation for PSFCH must be enhanced as well, and in this matter here in the following multiple embodiments are provided.

In one embodiment, the PSFCH sequence is composed by a long sequence of length equivalent to the total number of REs over which PSFCH must span. In one option, the base sequence generation to use can be that defined in Section 5.2.2 in TS 38.211 [1]. In another option, if the number of PRBs to use may be less than 3, then the base sequence generation as defined in Section 5.2.2.2 in 3GPP Technical Standard (TS) 38.211 [1] can be reused for r_{u,v}^{(α,δ)}(n) for the signal generation for PSFCH. In another option, when the number of PRBs is greater than 2, base sequence generation as defined in Section 5.2.2.1 in TS38.211 [1] can be reused for r_{u,v}^{(α,δ)}(n) for the signal generation for PSFCH.

In another embodiment, the PSFCH sequence is composed by a length-12 sequence as defined in Section 8.3.4.2.1 in TS 38.211 [1] which is repeats N times, where N is the number of RBs over which the PSFCH must span.

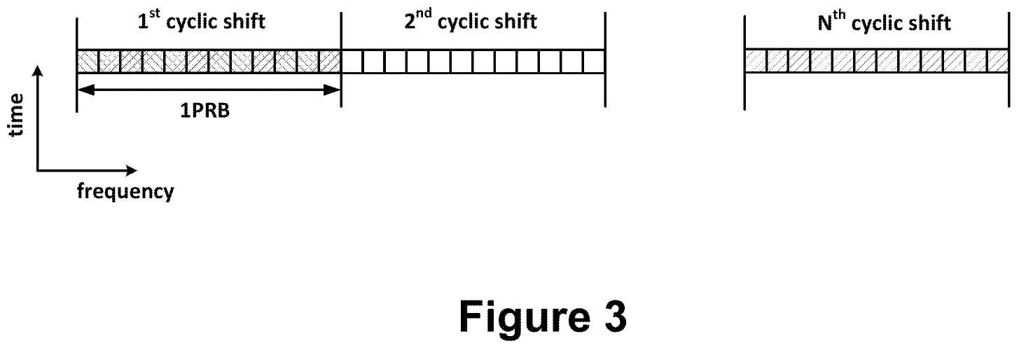

In another embodiment, the PSFCH sequence is composed by a length-12 sequence as defined in Section 8.3.4.2.1 in TS 38.211 [1] which is repeats N times, where N is the number of RBs over which the PSFCH must span. Further, cyclic shift hopping can be applied on the PSFCH transmission in different PRBs. This indicates that different cyclic shifts are applied for the transmission of PSFCH in different PRBs as illustrated in FIG. 3.

In one option, cyclic shift is incremented by a constant value in different PRBs. The constant value can be 1, 5, 7 or 11. In one example, assuming constant cyclic shift value as 5, cyclic shift for the first PRB is 5, then the cyclic shift for second PRB is 10, and the cyclic shift for third PRB is 3 (due to modulo operation with regards to 12), and so on.

In one option, the cycling of cyclic shifts across RBs is applied in a similar way as for Rel-16 for PF0/1 for the case that useInterlacePSCCH-PSSCH is configured, and in this case the cyclic shift α varies as a function of the symbol and slot number. As an example, the cyclic shift may be generated as follows:

$${α}_{l} = \frac{2 π}{{N}_{sc}^{RB}} ( ( {m}_{0} + {m}_{cs} + {m}_{int} + {n}_{cs} ( {n}_{s , f}^{μ} , l + {l}^{′} ) ) mod {N}_{sc}^{RB} )$$

where
n_{s,f}^{μ} is the slot number in the radio frame
l is the OFDM symbol number in the PSFCH transmission, where l=0 corresponds to the first OFDM symbol of the PSFCH transmission within a slot, in case PSFCH may span over multiple symbols, otherwise l=0,
l′ is the index of the OFDM symbol in the slot that corresponds to the first OFDM symbol of the PSFCH transmission in the slot
m₀ is fixed or given by an RRC parameter and may be chosen from a set of values such as {0, 6}.
m_{cs} may be fixed, or given by an RRC parameter or depend on the information to be transmitted. For example, m_{cs}=0 if HARQ-ACK value is 0 and m_{cs}=1 if HARQ-ACK value is 1, or viceversa.
mᵢₙₜ=5n_{RB}^{μ} if PSFCH shall use more than one PRBs for transmission, where n_{RB}^{μ} is the number of RBS over which PSFCH may span.

### PSFCH Design for 60 kHz Subcarrier Spacing

In one embodiment, an RB-based interlace design is adopted for 60 kHz SCS when the OCB and PSD restrictions from the ETSI BRAN must be met. In one option, an LBT BW is composed by two RB-based interlaces, where the first interlace is composed by X RBs, and the second interlace is composed by Y RBs, where X and Y could be 10, 11 or 12. Notice that in one option X=Y. In one embodiment, one of the following alternatives could be adopted:
A PSFCH transmission may span over a single PRB or a group of PRBs within a specific interlace. When PSFCH spans over multiple RBs, one of the options described herein may be adopted.
A PSFCH transmission may span over an entire interlace following one of the options described herein.

In one embodiment, when the OCB and PSD restrictions from the ETSI BRAN must be met, a PSFCH transmission may span over the entire LBW BW or over a group of RBs by following one of the options described herein.

### PSFCH Resource Determination in the Case of Multiple Transmission Opportunities

In contrast to Rel.16/17 SL for NR-U SL it is possible that a transmission opportunity cannot be used due to channel access procedure. For example, these resources could be taken by another system or incumbent technology operating in the same band. In addition, it also needs to be clear to which PSCCH/PSSCH transmission the feedback does belong.

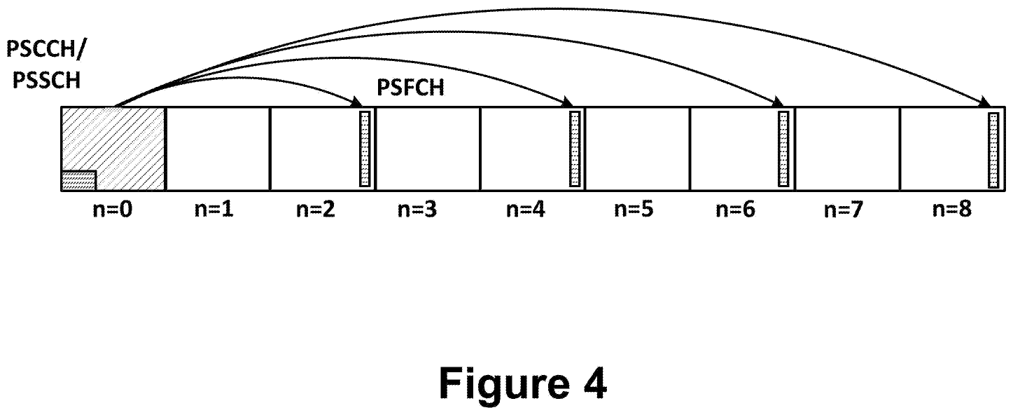

In one embodiment, multiple PSFCH transmission opportunities may be associated for a given PSCCH/PSSCH (as illustrated in FIG. 4), due to a one-to-many mapping of the PSFCH resource the recipient of the HARQ feedback may need to be able to identify that this is indeed feedback for its own transmission and the resource of the feedback needs to be uniquely defined per feedback occasion. This can be achieved via (pre)-configuration as part of the resource pool configuration. In one example, it may be possible to define a bitmap of PRBs per feedback occasion. This would result in different PSFCH resources being configured for each feedback occasion. Combined with the necessity to fulfil the OCB requirements this can be achieved by mapping the resources of each feedback occasion to a different interlaces.

In another embodiment, to enable PSFCH feedback for an FDMed transmission, for example as part of UE-to-UE COT sharing, it is necessary that there is always a one-to-one mapping between PSSCH transmissions and PSFCH feedback resources. This can also apply for multiple occasions (one-to-many mapping between a PSCCH/PSSCH transmission resource and PSFCH resource occasions), for example for the case that multiple FDMed transmission at the end of a shared COT required PSFCH feedback after the end of the shared COT.

In a third embodiment, to enable different operation of the PSFCH channel for the cases within and outside of UE-to-UE COT sharing, different configurations apply for these cases. For instance, for the case PSFCH falls within the shared COT of the corresponding PSCCH/PSSCH transmission resource, only one PSFCH occasion is configured, but different resources are associated with the potentially FDMed resources. For the case PSFCH falls outside of the shared COT of the corresponding PSCCH/PSSCH transmission resource, or for the case that the PSFCH feedback for last PSCCH/PSSCH transmissions within a shared COT cannot be performed inside the COT (due to processing requirements), there are multiple PSFCH occasions configured.

Notice that the embodiments above are not mutually exclusive and two or more may be used together.

### S-SSB Physical Structure

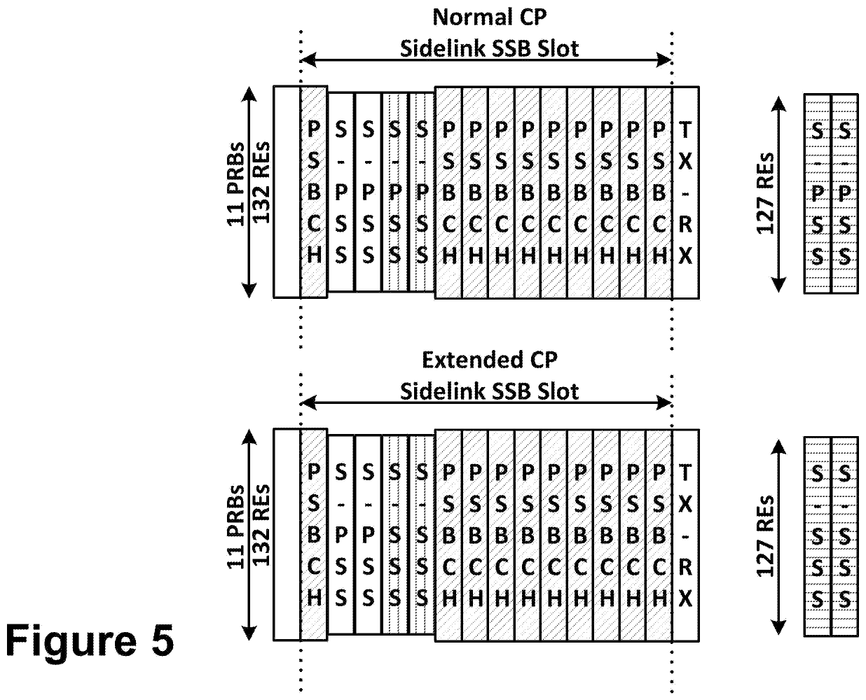

For Rel.16 SL, the physical structure of S-SSB design is shown in FIG. 5. As it is possible to note the S-SSB transmission spans over a relatively narrow band, which was motivated to reduce the complexity of SL synchronization search. As mentioned above, due to the OCB regulation requirements mandated by ETSI BRAN, the current S-SSB structure cannot be used and must be enhanced. In this sense, several embodiments are provided as discussed further below.

In one embodiment, the Rel. 16 SL S-SSB design defined for operation in licensed spectrum is reused when operating in unlicensed spectrum.

In one embodiment, only the 60 kHz S-SSB design is used among all SCS configurations when operating in unlicensed spectrum in FR1.

In one embodiment, only the 15 and 30 kHz S-SSB design is used among all SCS configurations when operating in unlicensed spectrum in FR1.

In one embodiment, a comb-structure is used for S-SSB transmissions (e.g., Comb-4 for 15 kHz, Comb-2 for 30 kHz and Comb-1 for 60 kHz). In this case the comb structure is on RE level.

In one embodiment, S-SSB follows an RB-based interlaced mapping, where the legacy S-SSB is mapped over a specific set of PRBs or group of PRBs which are spread over the all channel BW. In this case the original 11 PRBs are interleaved and mapped across specific PRBs that span along the whole bandwidth within a 20 MHz band.

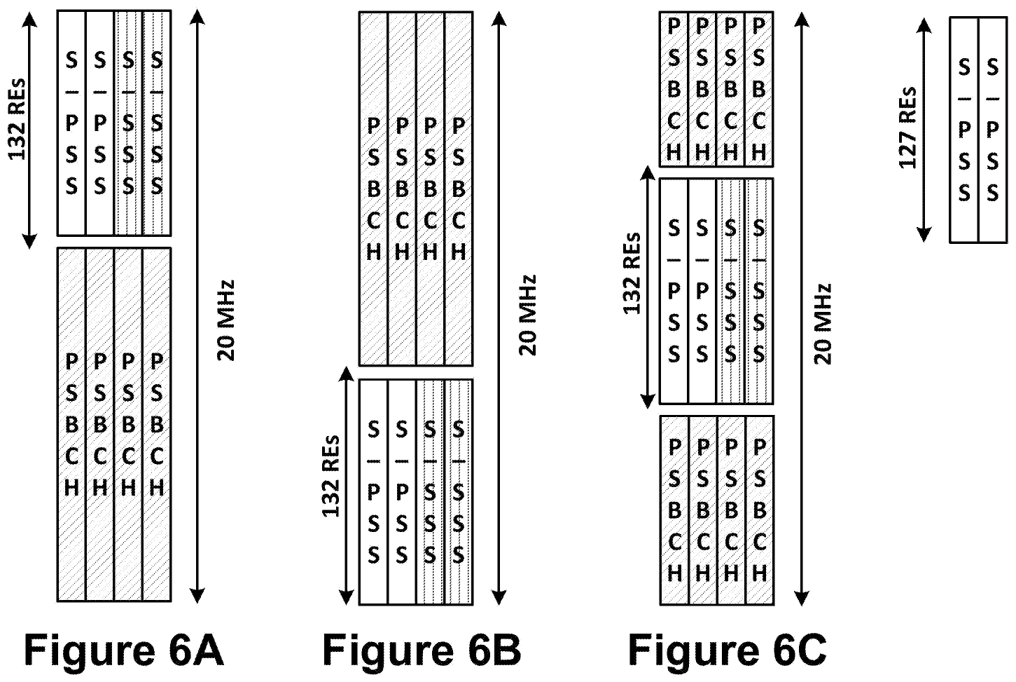

In one embodiment, S-SSB is mapped over the all-channel BW. In this case the S-SSB may be composed by X symbols (including or excluding a symbol at the beginning for AGC and one at the end for TX/RX switching), where X could be for example 4. In one embodiment, while the legacy S-PSS and S-SSS still span over 127 REs (occupying 11 PRBs) with no enhancements to their sequence design, PSBCH is either wrapped around S-PSS and S-SSS (as shown in FIG. 6C) or located in the upper PRBs (see FIG. 6A) or lower PRBs (see FIG. 6B) of an LBT BW by properly mapping it so that to span cumulatively over the entire 20 MHz band.

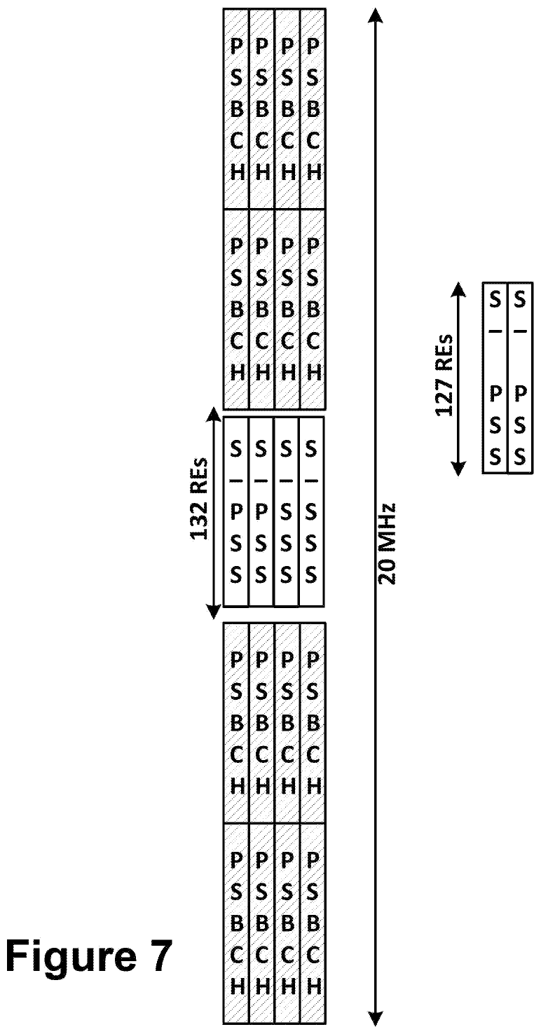

In one embodiment, S-SSB is mapped over the all-channel BW. In this case the S-SSB may be composed by X symbols (including or excluding a symbol at the beginning for AGC and one at the end for TX/RX switching), where X could be for example 4. In one embodiment, while the legacy S-PSS and S-SSS still span over 127 REs (occupying 11 PRBs) with no enhancements to their sequence design, the legacy PSBCH is repeated N times in frequency domain around S-PSS and S-SSS, where N is in function of the subcarrier spacing and is picked so that S-PSS+S-SSS+PSBCH spans in frequency domain cumulatively over the at least 80% of the channel bandwidth up to the entire 20 MHz band as illustrated as an example in FIG. 7.

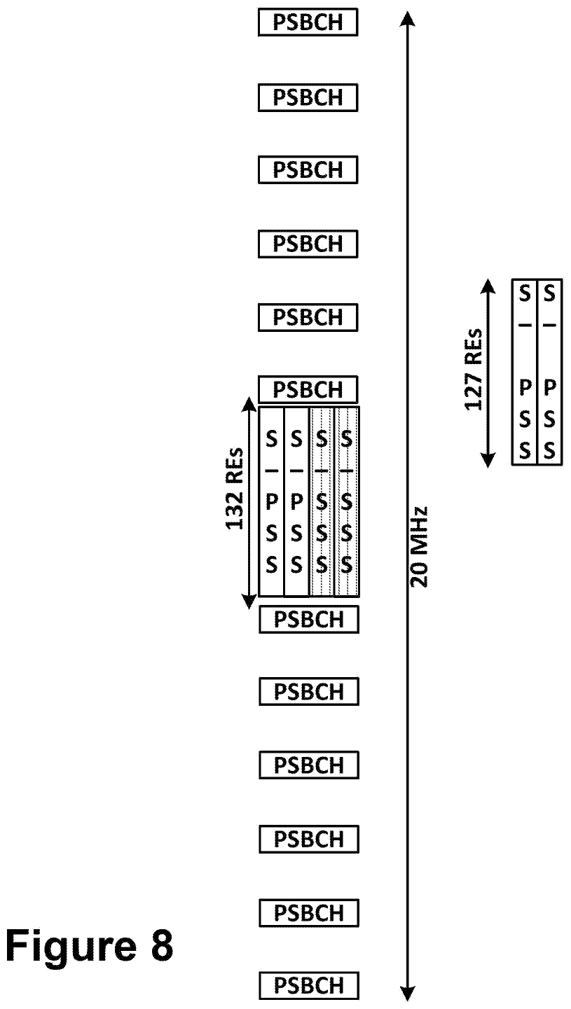

In one embodiment, S-SSB is mapped over the all-channel BW. In this case the S-SSB may be composed by X symbols (including or excluding a symbol at the beginning for AGC and one at the end for TX/RX switching), where X could be for example 4. In one embodiment, while the legacy S-PSS and S-SSS still span over 127 REs (occupying 11 PRBs) with no enhancements to their sequence design, the legacy PSBCH is transmitted around S-PSS and S-SSS in a comb manner, where the elements composing this structure can be at the REs, RB or group of RBs level, as illustrated in FIG. 8.

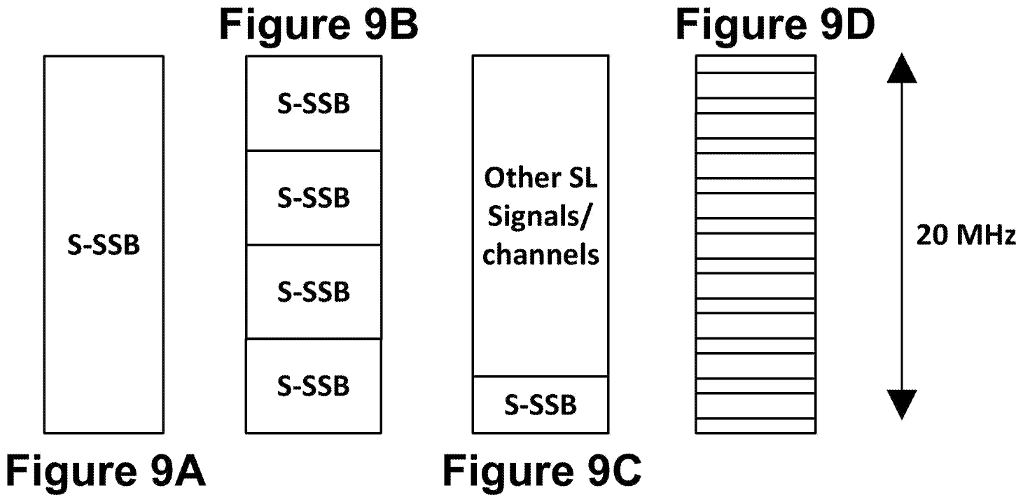

FIGS. 9A-9D illustrate various options to fulfill OCB requirements for S-SSB when operating in unlicensed spectrum.

In one embodiment, in order to meet the OCB requirements, the legacy S-SSB is repeated multiple times in frequency domain so that to meet at least the minimum 80% OCB requirement, and span at most 20 MHz.

In one embodiment, a design of wideband S-SSB is adopted, which implies that a S-SSB structure is defined. In particular, the new S-SSB may span over X number of symbols (including or excluding a symbol for TX/RX switching), where X could be for example 4. In one option, the S-PSS, S-SSS, and PSBCH may be rate matched/enhanced to span over the entire channel BW or over a BW which may be larger than the BW corresponding to 11 PRBS or may be 20 MHz. In one option, the S-SSB could be wrapped around with RMSI and/or PSSCH/PSCCH to span it over a minimum of 20 MHz.

In one embodiment, the MIB content for S-SSB may be enhanced, and the UE may interpret the MIB differently knowing that it operates in unlicensed spectrum from the specific channel raster used.

In one embodiment, the field ssb-SubcarrierOffset is modified, and this field corresponds to k̅_{SSB}, and k_{SSB} is obtained from k̅_{SSB} (see TS 38.211 [16], clause 7.4.3.1); the LSB of this field is used also for deriving the QCL relation between S-SSS/PSBCH blocks as done in Rel. 16 NR-U.

### S-SSB Physical Structure for 2 MHz Exemption

While ETSI BRAN mandates in EU regions a minimum of 80% occupied channel bandwidth, it also allows an exemption of this requirement for infrequent channels as indicated in the following text:

| | |
|---|---|
| 4.2.2 | Nominal Channel Bandwidth and Occupied Channel Bandwidth |
| 4.2.1 | Definition |

The Nominal Channel Bandwidth is the widest band of frequencies, inclusive of guard
bands, assigned to a single channel.
The Occupied Channel Bandwidth is the bandwidth containing 99% of the power of
the signal.
When equipment has simultaneous transmission in adjacent channels, these
transmissions may be considered as one signal with an actual Nominal Channel
Bandwidth of “n” times the individual Nominal Channel Bandwidth where “n” is the
number of adjacent channels. When equipment has simultaneous transmissions in
non-adjacent channels, each power envelope shall be considered separately.

| | |
|---|---|
| 4.2.2.2 | Limits |

The Nominal Channel Bandwidth for a single Operating Channel shall be 20 MHz.
Alternatively, equipment may implement a lower Nominal Channel Bandwidth with
a minimum of 5 MHz, providing they still comply with the Nominal Centre
Frequencies defined in clause 4.2.1 (20 MHz raster).
The Occupied Channel Bandwidth shall be between 80% and 100% of the Nominal
Channel Bandwidth. In case of smart antenna systems (devices with multiple transmit
chains) each of the transmit chains shall meet this requirement. The Occupied
Channel Bandwidth might change with time/payload.
During a Channel Occupancy Time (COT), equipment may operate temporarily with
an Occupied Channel Bandwidth of less than 80% of its Nominal Channel Bandwidth
with a minimum of 2 MHz.

As indicated in the highlighted text above, an equipment may be exempt from occupying 80% channel bandwidth if it may temporarily occupy a minimum of 2 MHz bandwidth. Among other channels/signals, this temporarily exemption could be applied in SL operating in unlicensed band to S-SSB. In this case, since the legacy Rel. 16 S-SSB spans over 11 PRBs, this exception may lead to reusing the legacy design as is for 30 and 60 kHz, while for 15 kHz the legacy design if supported may need to be enhanced to span over at least 12 PRBs to be complaint. In this sense, in the following multiple options have been disclosed.

In one embodiment, as the Rel. 16 NR SL S-SSB design for 30 kHz and above subcarrier spacing (e.g., 60 kHz) does occupy already 2 MHz of bandwidth the current design is reused. This means the system would consist of 2 identical symbols of S-PSS that is constructure as an m-sequency on 127 subcarriers modulated as QPSK symbols, 2 identical symbols of S-SSS using the same 127 subcarriers based on QPSK modulated gold sequency and an PSBCH. The PSBCH spans 132 subcarriers, uses comb-4 DMRS and QPSK modulation of the polar-code modulated information bits. It is possible however to reduce the number of OFDM symbols used for PSBCH as the number of information might also be reduced. In one option of this embodiment, a SL system operating in unlicensed spectrum does not support S-SSB transmissions at 15 KHz subcarrier spacing.

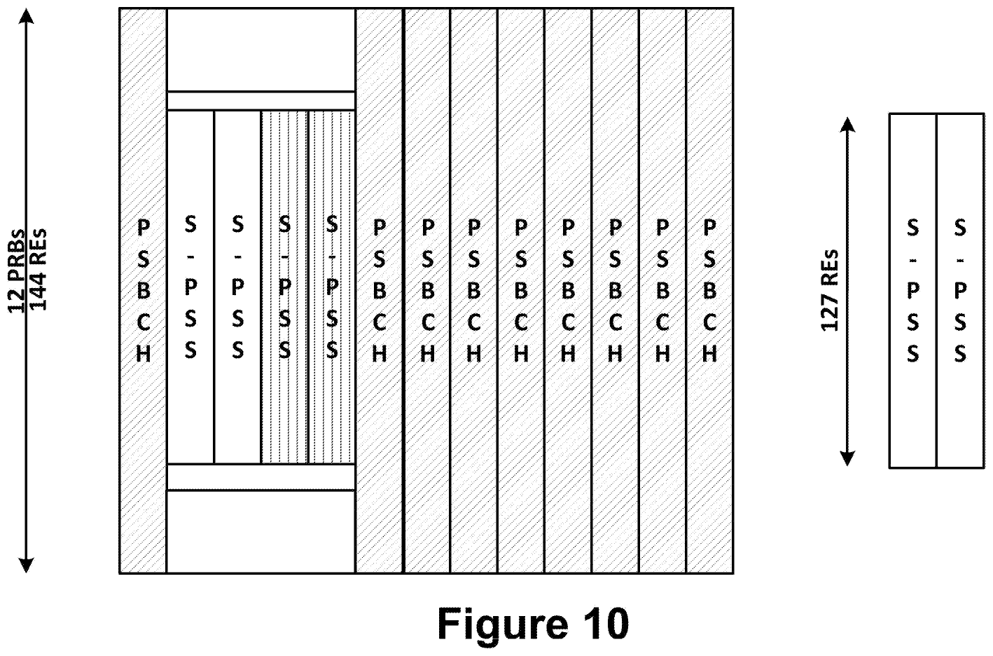

In one embodiment, a SL system operating in unlicensed spectrum supports S-SSB transmission at 15 KHz subcarrier spacing.
In one option of this embodiment, the S-PSS for system using 15 kHz subcarrier spacing is generated by adding a N copy of the Rel. 16/17 S-PSS in the frequency domain, where as an example N=2. Therefore, for N=2 the overall number of occupied subcarriers by the S-PSS would be 254 subcarriers. For this case the S-SSS can be extended in the same fashion as the S-PSS. The PSBCH would then occupy 11*N PRBs using the legacy comb-4 DMRS structure and polar coded information bits.
In another option, the complete S-SSB block comprising of S-PSS, S-SSS and PSBCH is repeated in frequency direction to span 11×N RBs, where as an example N=2. In this case, the PSBCH could be either included as a repeated block or could be the legacy PSBCH that is not repeated but simply rate-matched over 11×N RBs.
In another option, a different sequency of different length can be designed for the S-PSS. As total bandwidth needs to be at least 2 MHz, this means this sequency has to be at least of length of 133. In this case different constructions are possible: One would be to design a new sequency with perfect autocorrelation properties and a length larger or equal to 133. An example, it is possible to use a Legendre sequence, which can take a length equal to the closest prime number compared to the total number of REs over which the sequence may span. In case the S-PSS must span over 12 PRBs, a sequence of length of at least 133 could be used. Another option in this case is to combine multiple smaller length sequences of possibly different size to form a new sequency of the desired length. These S-PSS designs should all achieve the perfect autocorrelation property to enable multiple circular shifted versions of this sequence to represent part of the transmitted ID. The S-PSS sequence would also use BPSK as the modulation format and should be optimized for a low PAPR to maximize PA efficiency. In this case the S-SSS also needs to adapt to the length of the S-PSS. One option is to take portions of a larger gold sequence, also with the initialization value dependent on the ID. Another option is to cyclically extend the Rel. 16/17 Gold sequency of size 127 to the desired size. The PSBCH can be simply adapted to the next full number of RBs using the previous structure of comb-4 DMRS, QPSK modulation and polar coding. It is possible to adapt the number of OFDM symbols used for the PSBCH to the required coverage.
In another option, the legacy S-SSB is reused, and the legacy PSBCH mapping is enhanced so that PSBCH is mapped over at least 12 PRBs (and as another option additionally around S-PSS and S-SSS) as illustrated for example in FIG. 10.

### NR-U SL PSBCH (SL MIB) Content

Considering that the transmission in SL operating in unlicensed spectrum is conditional to the success of the LBT procedure, the content of the SL master information block may have different requirements for the operation in an unlicensed spectrum. This also means that the content needs to be adapted from the SL version for operating in a licensed spectrum.

In one embodiment, the PSBCH may contain one or more (e.g., all) of the following information fields:
Frame number of the frame in which the S-SSB is transmitted (DFN)
Slot index in which the S-SSB is transmitter
Indicator of whether the transmitting device is in or outside coverage of the DL cell operating in licensed band or in both in case SL UEs operating in unlicensed spectrum may rely on NR-U synchronization channels.
Reserved bits for future improvements
CRC (24 bit)

### Channel Access and Allocation of Resources for S-SSB Transmission

In SL Rel.16 design, the resources for S-SSB transmission are pre-configured in specific/dedicated slots, and S-SSB is transmitted periodically and by multiple UEs based on SFN. The same principles can be reused for S-SSB transmission in unlicensed spectrum. However, the S-SSB procedure and resource allocation may need to be enhanced to accommodate for the use of LBT and its uncertainty and possible failure when operating in unlicensed band. In this sense, several embodiments are provided along this section.

In one embodiment, a UE may qualify the S-SSB or its physical structure enhanced based on the embodiments above as a short control signaling. In this case, one of the following options could be applied:
Option 1: S-SSB is transmitted without any LBT measurements before its transmission.
Option 2: S-SSB is transmitted by performing Type 2A LBT before its transmission.

In case an S-SSB transmission is qualified as short control signaling, in one embodiment, regardless of whether Option 1 or 2 above is adopted, the 5% duty cycle is applied for device (e.g., regardless of whether it operates as initiating or responding device), meaning that the UE transmitting S-SSB will be responsible to meet the 5% duty cycle, otherwise type 1 LBT will be needed for any additional S-SSB transmission. In another option, regardless of whether Option 1 or 2 above is adopted, the 5% duty cycle is applied per “initiating” device, meaning the 5% is counted independently of the UE transmitting S-SSB by the UE that is initiating the COT. In other words, the UE only counts the aggregation time of all the channels that are qualified as short control signaling which are transmitted as if the UE is the initiating device, and it is left up to UE to be responsible to not exceed the 5% duty cycle and use type 1 LBT for any additional S-SSB transmission exceeding the 5% limit.

In one embodiment, UEs may be pre-configured to perform the related channel access procedure in a pre-configured set of slots prior or after the pre-configured S-SSB resources or with a pre-configured periodicity. In other words, a UE may be provided with the capability to perform LBT in multiple occasions within a given laps of time before or after the pre-configured S-SSB resources.

In one embodiment, UEs may be pre-configured to acquire a COT for an S-SSB transmission (S-SSB COT) within a pre-defined or pre-configured window prior or after a pre-configured S-SSB resources or with a pre-configured periodicity.

In one embodiment, within a shared COT initiated by a UE, the UE may be pre-configured to transmit any signal (S-SSB or dummy) if there is no actual data available for transmission in a pre-configured set of slots prior pre-configured S-SSB resources, so that S-SSB may be transmitted without the need to perform any LBT measurement before transmitting it.

In one embodiment, a UE may transmit a SL transmission in a slot prior to S-SSB allocation to support a predefined gap or a gap less than 16 us before the S-SSB transmission.

In one embodiment, a UE may transmit S-SSB w/o LBT energy measurement, e.g., use Type-2C LBT, if a UE detects SL transmission in a slot(s) preceding S-SSB allocation with a gap <16 us. Otherwise, UE is expected to use Type-2A/2B or Type-1 LBT.

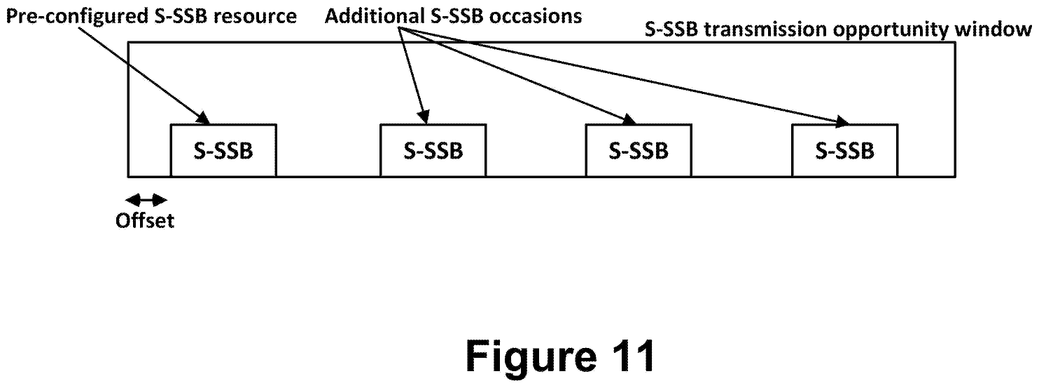

In one embodiment, UEs may be pre-configured with an S-SSB transmission opportunity window to enable additional opportunities for S-SSB transmission considering that S-SSB transmission on pre-configured resource may not be guaranteed. The S-SSB transmission opportunity window can be pre-configured relative to the pre-configured S-SSB resources, as illustrate in FIG. 11. In this case, in one option the length of the window and/or the number of occurrence of S-SSB, which would span in time in an equidistant manner, within the window, e.g. number of S-SSB transmission opportunities within the window, could be pre-configured among a given set of values. When an S-SSB transmission opportunity window is pre-configured, a UE may perform an LBT procedure (e.g., type-1 or type-2 LBT) associated to such transmission before the first S-SSB occasion and if LBT may fail, it may try to succeed the LBT procedure in the following S-SSB occasion, but if the LBT procedure may succeed a UE may be allowed to perform the S-SSB transmission associated to that occasion and should not attempt transmission in any remaining occasions within that window.

In one option, the above enhancement could be employed via one or more of the following:
A new higher layer parameter is introduced, which indicates the number of occasions within X ms, or X slots where X may be fixed or (pre-) configured, or the number of consecutive occasions each in every consecutive slots within a period.
The parameter sl-NumSSB-WithinPeriod-r16 is enhanced so that to increase the available values compared to the current set (e.g, {n1, n2, n4, n8, n16, n32, n64}).
The parameter sl-NumSSB-WithinPeriod-r16 is interpreted as the number of S-SSB occasions within X ms, or X slots where X may be fixed or (pre-) configured, or the number of consecutive occasions in consecutive slots within a period.
A new higher layer parameters is introduced which indicates the offset between the S-SSB period and the start of the first (pre-) configured S-SSB resource.
Two new higher layer parameters are introduced: one that indicates the offset between the S-SSB period and the start of the first (pre-) configured S-SSB resource, and another which indicates the time interval between two S-SSB occasion. The number of S-SSB occasions within a period are determined based on the sub-carrier spacing and/or the length of a window which may be fixed or (pre-) configured.

In one option, when S-SSB is transmitted using a type 2A LBT or 2C LBT, when (pre-) configuring the additional S-SSB occasions, the number of occasions may not exceed 1/20 duty cycle over any observation period of 50 ms.

In one embodiment, the resources associated to NR SL S-SSB (including or excluding those associated to the additional occasions, if supported) are excluded from the resource pool configuration.

In one embodiment, UEs may be pre-configured to use cyclic prefix or cyclic postfix extension at the start or end of a SL S-SSB transmission respectively to simplify LBT procedure before and after S-SSB transmission (e.g., within a S-SSB COT) or to allow a device to transmit soon after it has assessed that the channel is idle.

### S-SSB Less Operation

In one embodiment, it may be possible to enable a SL system that does not require S-SSB. In this case, the synchronization is only based on other sources of synchronization like GNSS or network synchronization. In one option, a higher layer signaling is required to disable S-SSB transmissions. In another option, the S-SSB less operation could be configured per resource pool and may be indicated as part of sl-TxPoolScheduling or within the SL-ResourcePool IE.

Note that some of the options/embodiments provided in this disclosure are not mutually exclusive but can be jointly adopted.

### Systems and Implementations

FIGS. 12-14 illustrate various systems, devices, and components that may implement aspects of disclosed embodiments.

FIG. 12 illustrates a network 1200 in accordance with various embodiments. The network 1200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1200 may include a UE 1202, which may include any mobile or non-mobile computing device designed to communicate with a RAN 1204 via an over-the-air connection. The UE 1202 may be communicatively coupled with the RAN 1204 by a Uu interface. The UE 1202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1202 may additionally communicate with an AP 1206 via an over-the-air connection. The AP 1206 may manage a WLAN connection, which may serve to offload some/all network traffic from the RAN 1204. The connection between the UE 1202 and the AP 1206 may be consistent with any IEEE 802.11 protocol, wherein the AP 1206 could be a wireless fidelity (Wi-Fi®) router. In some embodiments, the UE 1202, RAN 1204, and AP 1206 may utilize cellular-WLAN aggregation (for example, LWA/LWIP). Cellular-WLAN aggregation may involve the UE 1202 being configured by the RAN 1204 to utilize both cellular radio resources and WLAN resources.

The RAN 1204 may include one or more access nodes, for example, AN 1208. AN 1208 may terminate air-interface protocols for the UE 1202 by providing access stratum protocols including RRC, PDCP, RLC, MAC, and L1 protocols. In this manner, the AN 1208 may enable data/voice connectivity between CN 1220 and the UE 1202. In some embodiments, the AN 1208 may be implemented in a discrete device or as one or more software entities running on server computers as part of, for example, a virtual network, which may be referred to as a CRAN or virtual baseband unit pool. The AN 1208 be referred to as a BS, gNB, RAN node, eNB, ng-eNB, NodeB, RSU, TRxP, TRP, etc. The AN 1208 may be a macrocell base station or a low power base station for providing femtocells, picocells or other like cells having smaller coverage areas, smaller user capacity, or higher bandwidth compared to macrocells.

In embodiments in which the RAN 1204 includes a plurality of ANs, they may be coupled with one another via an X2 interface (if the RAN 1204 is an LTE RAN) or an Xn interface (if the RAN 1204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1204 may each manage one or more cells, cell groups, component carriers, etc. to provide the UE 1202 with an air interface for network access. The UE 1202 may be simultaneously connected with a plurality of cells provided by the same or different ANs of the RAN 1204. For example, the UE 1202 and RAN 1204 may use carrier aggregation to allow the UE 1202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1202 or AN 1208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1204 may be an LTE RAN 1210 with eNBs, for example, eNB 1212. The LTE RAN 1210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1204 may be an NG-RAN 1214 with gNBs, for example, gNB 1216, or ng-eNBs, for example, ng-eNB 1218. The gNB 1216 may connect with 5G-enabled UEs using a 5G NR interface. The gNB 1216 may connect with a 5G core through an NG interface, which may include an N2 interface or an N3 interface. The ng-eNB 1218 may also connect with the 5G core through an NG interface, but may connect with a UE via an LTE air interface. The gNB 1216 and the ng-eNB 1218 may connect with each other over an Xn interface.

In some embodiments, the NG interface may be split into two parts, an NG user plane (NG-U) interface, which carries traffic data between the nodes of the NG-RAN 1214 and a UPF 1248 (e.g., N3 interface), and an NG control plane (NG-C) interface, which is a signaling interface between the nodes of the NG-RAN1214 and an AMF 1244 (e.g., N2 interface).

The NG-RAN 1214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1202 can be configured with multiple BWPs where each BWP configuration has a different SCS. When a BWP change is indicated to the UE 1202, the SCS of the transmission is changed as well. Another use case example of BWP is related to power saving. In particular, multiple BWPs can be configured for the UE 1202 with different amount of frequency resources (for example, PRBs) to support data transmission under different traffic loading scenarios. A BWP containing a smaller number of PRBs can be used for data transmission with small traffic load while allowing power saving at the UE 1202 and in some cases at the gNB 1216. A BWP containing a larger number of PRBs can be used for scenarios with higher traffic load.

The RAN 1204 is communicatively coupled to CN 1220 that includes network elements to provide various functions to support data and telecommunications services to customers/subscribers (for example, users of UE 1202). The components of the CN 1220 may be implemented in one physical node or separate physical nodes. In some embodiments, NFV may be utilized to virtualize any or all of the functions provided by the network elements of the CN 1220 onto physical compute/storage resources in servers, switches, etc. A logical instantiation of the CN 1220 may be referred to as a network slice, and a logical instantiation of a portion of the CN 1220 may be referred to as a network sub-slice.

In some embodiments, the CN 1220 may be an LTE CN 1222, which may also be referred to as an EPC. The LTE CN 1222 may include MME 1224, SGW 1226, SGSN 1228, HSS 1230, PGW 1232, and PCRF 1234 coupled with one another over interfaces (or “reference points”) as shown. Functions of the elements of the LTE CN 1222 may be briefly introduced as follows.

The MME 1224 may implement mobility management functions to track a current location of the UE 1202 to facilitate paging, bearer activation/deactivation, handovers, gateway selection, authentication, etc.

The SGW 1226 may terminate an SI interface toward the RAN and route data packets between the RAN and the LTE CN 1222. The SGW 1226 may be a local mobility anchor point for inter-RAN node handovers and also may provide an anchor for inter-3GPP mobility. Other responsibilities may include lawful intercept, charging, and some policy enforcement.

The SGSN 1228 may track a location of the UE 1202 and perform security functions and access control. In addition, the SGSN 1228 may perform inter-EPC node signaling for mobility between different RAT networks; PDN and S-GW selection as specified by MME 1224; MME selection for handovers; etc. The S3 reference point between the MME 1224 and the SGSN 1228 may enable user and bearer information exchange for inter-3GPP access network mobility in idle/active states.

The HSS 1230 may include a database for network users, including subscription-related information to support the network entities' handling of communication sessions. The HSS 1230 can provide support for routing/roaming, authentication, authorization, naming/addressing resolution, location dependencies, etc. An S6a reference point between the HSS 1230 and the MME 1224 may enable transfer of subscription and authentication data for authenticating/authorizing user access to the LTE CN 1220.

The PGW 1232 may terminate an SGi interface toward a data network (DN) 1236 that may include an application/content server 1238. The PGW 1232 may route data packets between the LTE CN 1222 and the data network 1236. The PGW 1232 may be coupled with the SGW 1226 by an S5 reference point to facilitate user plane tunneling and tunnel management. The PGW 1232 may further include a node for policy enforcement and charging data collection (for example, PCEF). Additionally, the SGi reference point between the PGW 1232 and the data network 12 36 may be an operator external public, a private PDN, or an intra-operator packet data network, for example, for provision of IMS services. The PGW 1232 may be coupled with a PCRF 1234 via a Gx reference point.

The PCRF 1234 is the policy and charging control element of the LTE CN 1222. The PCRF 1234 may be communicatively coupled to the app/content server 1238 to determine appropriate QoS and charging parameters for service flows. The PCRF 1232 may provision associated rules into a PCEF (via Gx reference point) with appropriate TFT and QCI.

In some embodiments, the CN 1220 may be a 5GC 1240. The 5GC 1240 may include an AUSF 1242, AMF 1244, SMF 1246, UPF 1248, NSSF 1250, NEF 1252, NRF 1254, PCF 1256, UDM 1258, and AF 1260 coupled with one another over interfaces (or “reference points”) as shown. Functions of the elements of the 5GC 1240 may be briefly introduced as follows.

The AUSF 1242 may store data for authentication of UE 1202 and handle authentication-related functionality. The AUSF 1242 may facilitate a common authentication framework for various access types. In addition to communicating with other elements of the 5GC 1240 over reference points as shown, the AUSF 1242 may exhibit an Nausf service-based interface.

The AMF 1244 may allow other functions of the 5GC 1240 to communicate with the UE 1202 and the RAN 1204 and to subscribe to notifications about mobility events with respect to the UE 1202. The AMF 1244 may be responsible for registration management (for example, for registering UE 1202), connection management, reachability management, mobility management, lawful interception of AMF-related events, and access authentication and authorization. The AMF 1244 may provide transport for SM messages between the UE 1202 and the SMF 1246, and act as a transparent proxy for routing SM messages. AMF 1244 may also provide transport for SMS messages between UE 1202 and an SMSF. AMF 1244 may interact with the AUSF 1242 and the UE 1202 to perform various security anchor and context management functions. Furthermore, AMF 1244 may be a termination point of a RAN CP interface, which may include or be an N2 reference point between the RAN 1204 and the AMF 1244; and the AMF 1244 may be a termination point of NAS (N1) signaling, and perform NAS ciphering and integrity protection. AMF 1244 may also support NAS signaling with the UE 1202 over an N3 IWF interface.

The SMF 1246 may be responsible for SM (for example, session establishment, tunnel management between UPF 1248 and AN 1208); UE IP address allocation and management (including optional authorization); selection and control of UP function; configuring traffic steering at UPF 1248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1244 over N2 to AN 1208; and determining SSC mode of a session. SM may refer to management of a PDU session, and a PDU session or “session” may refer to a PDU connectivity service that provides or enables the exchange of PDUs between the UE 1202 and the data network 1236.

The UPF 1248 may act as an anchor point for intra-RAT and inter-RAT mobility, an external PDU session point of interconnect to data network 1236, and a branching point to support multi-homed PDU session. The UPF 1248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1248 may include an uplink classifier to support routing traffic flows to a data network.

The NSSF 1250 may select a set of network slice instances serving the UE 1202. The NSSF 1250 may also determine allowed NSSAI and the mapping to the subscribed S-NSSAIs, if needed. The NSSF 1250 may also determine the AMF set to be used to serve the UE 1202, or a list of candidate AMFs based on a suitable configuration and possibly by querying the NRF 1254. The selection of a set of network slice instances for the UE 1202 may be triggered by the AMF 1244 with which the UE 1202 is registered by interacting with the NSSF 1250, which may lead to a change of AMF. The NSSF 1250 may interact with the AMF 1244 via an N22 reference point; and may communicate with another NSSF in a visited network via an N31 reference point (not shown). Additionally, the NSSF 1250 may exhibit an Nnssf service-based interface.

The NEF 1252 may securely expose services and capabilities provided by 3GPP network functions for third party, internal exposure/re-exposure, AFs (e.g., AF 1260), edge computing or fog computing systems, etc. In such embodiments, the NEF 1252 may authenticate, authorize, or throttle the AFs. NEF 1252 may also translate information exchanged with the AF 1260 and information exchanged with internal network functions. For example, the NEF 1252 may translate between an AF-Service-Identifier and an internal 5GC information. NEF 1252 may also receive information from other NFs based on exposed capabilities of other NFs. This information may be stored at the NEF 1252 as structured data, or at a data storage NF using standardized interfaces. The stored information can then be re-exposed by the NEF 1252 to other NFs and AFs, or used for other purposes such as analytics. Additionally, the NEF 1252 may exhibit an Nnef service-based interface.

The NRF 1254 may support service discovery functions, receive NF discovery requests from NF instances, and provide the information of the discovered NF instances to the NF instances. NRF 1254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1254 may exhibit the Nnrf service-based interface.

The PCF 1256 may provide policy rules to control plane functions to enforce them, and may also support unified policy framework to govern network behavior. The PCF 1256 may also implement a front end to access subscription information relevant for policy decisions in a UDR of the UDM 1258. In addition to communicating with functions over reference points as shown, the PCF 1256 exhibit an Npcf service-based interface.

The UDM 1258 may handle subscription-related information to support the network entities' handling of communication sessions, and may store subscription data of UE 1202. For example, subscription data may be communicated via an N8 reference point between the UDM 1258 and the AMF 1244. The UDM 1258 may include two parts, an application front end and a UDR. The UDR may store subscription data and policy data for the UDM 1258 and the PCF 1256, and/or structured data for exposure and application data (including PFDs for application detection, application request information for multiple UEs 1202) for the NEF 1252. The Nudr service-based interface may be exhibited by the UDR 221 to allow the UDM 1258, PCF 1256, and NEF 1252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1258 may exhibit the Nudm service-based interface.

The AF 1260 may provide application influence on traffic routing, provide access to NEF, and interact with the policy framework for policy control.

In some embodiments, the 5GC 1240 may enable edge computing by selecting operator/3^{rd} party services to be geographically close to a point that the UE 1202 is attached to the network. This may reduce latency and load on the network. To provide edge-computing implementations, the 5GC 1240 may select a UPF 1248 close to the UE 1202 and execute traffic steering from the UPF 1248 to data network 1236 via the N6 interface. This may be based on the UE subscription data, UE location, and information provided by the AF 1260. In this way, the AF 1260 may influence UPF (re) selection and traffic routing. Based on operator deployment, when AF 1260 is considered to be a trusted entity, the network operator may permit AF 1260 to interact directly with relevant NFs. Additionally, the AF 1260 may exhibit an Naf service-based interface.

The data network 1236 may represent various network operator services, Internet access, or third party services that may be provided by one or more servers including, for example, application/content server 1238.

FIG. 13 schematically illustrates a wireless network 1300 in accordance with various embodiments. The wireless network 1300 may include a UE 1302 in wireless communication with an AN 1304. The UE 1302 and AN 1304 may be similar to, and substantially interchangeable with, like-named components described elsewhere herein.

The UE 1302 may be communicatively coupled with the AN 1304 via connection 1306. The connection 1306 is illustrated as an air interface to enable communicative coupling, and can be consistent with cellular communications protocols such as an LTE protocol or a 5G NR protocol operating at mm Wave or sub-6 GHZ frequencies.

The UE 1302 may include a host platform 1308 coupled with a modem platform 1310. The host platform 1308 may include application processing circuitry 1312, which may be coupled with protocol processing circuitry 1314 of the modem platform 1310. The application processing circuitry 1312 may run various applications for the UE 1302 that source/sink application data. The application processing circuitry 1312 may further implement one or more layer operations to transmit/receive application data to/from a data network. These layer operations may include transport (for example UDP) and Internet (for example, IP) operations

The protocol processing circuitry 1314 may implement one or more of layer operations to facilitate transmission or reception of data over the connection 1306. The layer operations implemented by the protocol processing circuitry 1314 may include, for example, MAC, RLC, PDCP, RRC and NAS operations.

The modem platform 1310 may further include digital baseband circuitry 1316 that may implement one or more layer operations that are “below” layer operations performed by the protocol processing circuitry 1314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1310 may further include transmit circuitry 1318, receive circuitry 1320, RF circuitry 1322, and RF front end (RFFE) 1324, which may include or connect to one or more antenna panels 1326. Briefly, the transmit circuitry 1318 may include a digital-to-analog converter, mixer, intermediate frequency (IF) components, etc.; the receive circuitry 1320 may include an analog-to-digital converter, mixer, IF components, etc.; the RF circuitry 1322 may include a low-noise amplifier, a power amplifier, power tracking components, etc.; RFFE 1324 may include filters (for example, surface/bulk acoustic wave filters), switches, antenna tuners, beamforming components (for example, phase-array antenna components), etc. The selection and arrangement of the components of the transmit circuitry 1318, receive circuitry 1320, RF circuitry 1322, RFFE 1324, and antenna panels 1326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1314 may include one or more instances of control circuitry (not shown) to provide control functions for the transmit/receive components.

A UE reception may be established by and via the antenna panels 1326, RFFE 1324, RF circuitry 1322, receive circuitry 1320, digital baseband circuitry 1316, and protocol processing circuitry 1314. In some embodiments, the antenna panels 1326 may receive a transmission from the AN 1304 by receive-beamforming signals received by a plurality of antennas/antenna elements of the one or more antenna panels 1326.

A UE transmission may be established by and via the protocol processing circuitry 1314, digital baseband circuitry 1316, transmit circuitry 1318, RF circuitry 1322, RFFE 1324, and antenna panels 1326. In some embodiments, the transmit components of the UE 1304 may apply a spatial filter to the data to be transmitted to form a transmit beam emitted by the antenna elements of the antenna panels 1326.

Similar to the UE 1302, the AN 1304 may include a host platform 1328 coupled with a modem platform 1330. The host platform 1328 may include application processing circuitry 1332 coupled with protocol processing circuitry 1334 of the modem platform 1330. The modem platform may further include digital baseband circuitry 1336, transmit circuitry 1338, receive circuitry 1340, RF circuitry 1342, RFFE circuitry 1344, and antenna panels 1346. The components of the AN 1304 may be similar to and substantially interchangeable with like-named components of the UE 1302. In addition to performing data transmission/reception as described above, the components of the AN 1308 may perform various logical functions that include, for example, RNC functions such as radio bearer management, uplink and downlink dynamic radio resource management, and data packet scheduling.

FIG. 14 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors (or processor cores) 1410, one or more memory/storage devices 1420, and one or more communication resources 1430, each of which may be communicatively coupled via a bus 1440 or other interface circuitry. For embodiments where node virtualization (e.g., NFV) is utilized, a hypervisor 1402 may be executed to provide an execution environment for one or more network slices/sub-slices to utilize the hardware resources 1400.

The processors 1410 may include, for example, a processor 1412 and a processor 1414. The processors 1410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1420 may include main memory, disk storage, or any suitable combination thereof. The memory/storage devices 1420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1430 may include interconnection or network interface controllers, components, or other suitable devices to communicate with one or more peripheral devices 1404 or one or more databases 1406 or other network elements via a network 1408. For example, the communication resources 1430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1450 may comprise software, a program, an application, an applet, an app, or other executable code for causing at least any of the processors 1410 to perform any one or more of the methodologies discussed herein. The instructions 1450 may reside, completely or partially, within at least one of the processors 1410 (e.g., within the processor's cache memory), the memory/storage devices 1420, or any suitable combination thereof. Furthermore, any portion of the instructions 1450 may be transferred to the hardware resources 1400 from any combination of the peripheral devices 1404 or the databases 1406. Accordingly, the memory of processors 1410, the memory/storage devices 1420, the peripheral devices 1404, and the databases 1406 are examples of computer-readable and machine-readable media.

### EXAMPLE PROCEDURES

In some embodiments, the electronic device(s), network(s), system(s), chip(s) or component(s), or portions or implementations thereof, of FIGS. 12-14, or some other figure herein, may be configured to perform one or more processes, techniques, or methods as described herein, or portions thereof. For example, FIG. 15 illustrates a process 1500 in accordance with various embodiments herein. The process 1500 may be performed by a UE or a portion thereof. At 1502, the process 1500 may include receiving a physical sidelink control channel (PSCCH) or a physical sidelink shared channel (PSSCH). At 1504, the process 1500 may further include identifying sidelink resources for a plurality of physical sidelink feedback channel (PSFCH) occasions associated with the PSCCH or PSSCH, wherein the sidelink resources are identified based on mapping information that defines the sidelink resources for respective individual PSFCH occasions of the plurality of PSFCH occasions. At 1506, the process 1500 may further include transmitting a PSFCH in one or more of the PSFCH occasions using the respective sidelink resources.

FIG. 16 illustrates another example process 1600 in accordance with various embodiments. The process 1600 may be performed by a UE or a portion thereof. At 1602, the process 1600 may include determining that a sidelink synchronization signal block (S-SSB) qualifies as short control signalling. At 1604, the process 1600 may further include performing a Type 2A listen-before-talk (LBT) procedure for the S-SSB based on the determination. At 1606, the process 1600 may further include transmitting the S-SSB based on a successful result of the Type 2A LBT procedure.

FIG. 17 illustrates another example process 1700 in accordance with various embodiments. The process 1700 may be performed by a UE or a portion thereof. At 1702, the process 1700 may include identifying sidelink resources for a physical sidelink feedback channel (PSFCH), wherein the sidelink resources include a set of resource blocks (RBs) that are interlaced in the frequency domain. At 1704, the process 1700 may further include transmitting the PSFCH in the identified sidelink resources.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Some non-limiting examples of various embodiments are provided below.

Example 1 may include one or more non-transitory computer-readable media (NTCRM) having instructions, stored thereon, that when executed by one or more processors of a user equipment (UE) configure the UE to: receive a physical sidelink control channel (PSCCH) or a physical sidelink shared channel (PSSCH); identify sidelink resources for a plurality of physical sidelink feedback channel (PSFCH) occasions associated with the PSCCH or PSSCH, wherein the sidelink resources are identified based on mapping information that defines the sidelink resources for respective individual PSFCH occasions of the plurality of PSFCH occasions; and transmit a PSFCH in one or more of the PSFCH occasions using the respective sidelink resources.

Example 2 may include the one or more NTCRM of example 1, wherein the instructions, when executed, further configure the UE to receive the mapping information as part of configuration information for a resource pool.

Example 3 may include the one or more NTCRM of example 1, wherein the sidelink resources for different PSFCH occasions include different physical resource blocks (PRBs) in a frequency domain.

Example 4 may include the one or more NTCRM of example 1, wherein the instructions, when executed, further configure the UE to: determine that the PSFCH is to be transmitted outside of a channel occupancy time (COT) shared by another device; and perform, based on the determination, a listen-before-talk (LBT) procedure for the transmission of the PSFCH.

Example 5 may include the one or more NTCRM of any one of examples 1-4, wherein the sidelink resources for the respective individual PSFCH occasions include a set of resource blocks that are interlaced in a frequency domain.

Example 6 may include the one or more NTCRM of example 5, wherein a frequency-domain orthogonal cover code (OCC) is applied for the transmission of the PSFCH.

Example 7 may include the one or more NTCRM of example 5, wherein a PRB-level cyclic shift is applied for the transmission of the PSFCH.

Example 8 may include the one or more NTCRM of any one of examples 1-4, wherein the sidelink resources includes a set of interlaced resource blocks that are common for PSFCHs of multiple UEs, and one or more dedicated physical resource blocks (PRBs) that are dedicated to the respective individual PSFCH occasion.

Example 9 may include one or more non-transitory computer-readable media (NTCRM) having instructions, stored thereon, that when executed by one or more processors of a user equipment (UE) configure the UE to: determine that a sidelink synchronization signal block (S-SSB) qualifies as short control signalling; perform a Type 2A listen-before-talk (LBT) procedure for the S-SSB based on the determination; and transmit the S-SSB based on a successful result of the Type 2A LBT procedure.

Example 10 may include the one or more NTCRM of example 9, wherein the determination is made based on a determination that the S-SSB has no greater than a 5% duty cycle.

Example 11 may include the one or more NTCRM of example 9, wherein the S-SSB includes a sidelink primary synchronization signal (S-PSS), a sidelink secondary synchronization signal (S-SSS), and a sidelink physical broadcast channel (S-PBCH) that are transmitted on resource blocks that are interlaced over a channel bandwidth.

Example 12 may include the one or more NTCRM of example 9, wherein to transmit the S-SSB includes to repeat the S-SSB in a frequency domain with a frequency gap between the repetitions.

Example 13 may include the one or more NTCRM of example 9, wherein the S-SSB is exempted from an occupied channel bandwidth (OCB) requirement.

Example 14 may include the one or more NTCRM of any one of examples 9-13, further comprising receiving configuration information for a S-SSB transmission window that includes a plurality of S-SSB occasions, wherein the S-SSB is transmitted in one or more of the S-SSB occasions.

Example 15 may include the one or more NTCRM of example 14, wherein the instructions, when executed, further configure the UE to: perform a first LBT procedure prior to a first S-SSB occasion of the plurality of S-SSB occasions; if the LBT procedure is successful, transmit the S-SSB in the first S-SSB occasion and not in remaining S-SSB occasions of the S-SSB transmission window; and if the first LBT procedure is unsuccessful, perform a second LBT procedure prior to a second S-SSB occasion and transmit the S-SSB in the second S-SSB occasion if the second LBT procedure is successful.

Example 16 may include one or more non-transitory computer-readable media (NTCRM) having instructions, stored thereon, that when executed by one or more processors of a user equipment (UE) configure the UE to: identify sidelink resources for a physical sidelink feedback channel (PSFCH), wherein the sidelink resources include a set of resource blocks (RBs) that are interlaced in the frequency domain; and transmit the PSFCH in the identified sidelink resources.

Example 17 may include the one or more NTCRM of example 16, wherein the set of RBs is a common set of RBs that is used for PSFCH transmissions by a plurality of UEs, and wherein the identified sidelink resources further include one or more dedicated physical resource blocks (PRBs) that are dedicated to the UE.

Example 18 may include the one or more NTCRM of example 16, wherein the instructions, when executed, further configure the UE to apply a frequency-domain orthogonal cover code to the PSFCH transmission.

Example 19 may include the one or more NTCRM of example 16, wherein the instructions, when executed, further configure the UE to apply a PRB-level cyclic shift to the PSFCH transmission.

Example 20 may include the one or more NTCRM of any one of examples 16-19, wherein the instructions, when executed, further configure the UE to: determine that the PSFCH is to be transmitted outside of a channel occupancy time (COT) shared by another device; and perform, based on the determination, a listen-before-talk (LBT) procedure for the transmission of the PSFCH.

Example 21 may include the physical structure for PSFCH for a SL system operating in unlicensed spectrum as described herein.

Example 22 may include an interleaved mapping for PSFCH structure for a SL system operating in unlicensed spectrum as described herein.

Example 23 may include the sequence design of PSFCH when it spans over more than one PRB as described herein.

Example 24 may include the physical structure for S-SSB for a SL system operating in unlicensed spectrum as described herein.

Example 25 may include the channel access mechanism and UE behavior to transmit for PFSCH and S-SSB as described herein.

Example Z01 may include an apparatus comprising means to perform one or more elements of a method described in or related to any of examples 1-25, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example Z03 may include an apparatus comprising logic, modules, or circuitry to perform one or more elements of a method described in or related to any of examples 1-25, or any other method or process described herein.

Example Z04 may include a method, technique, or process as described in or related to any of examples 1-25, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example Z06 may include a signal as described in or related to any of examples 1-25, or portions or parts thereof.

Example Z07 may include a datagram, packet, frame, segment, protocol data unit (PDU), or message as described in or related to any of examples 1-25, or portions or parts thereof, or otherwise described in the present disclosure.

Example Z08 may include a signal encoded with data as described in or related to any of examples 1-25, or portions or parts thereof, or otherwise described in the present disclosure.

Example Z09 may include a signal encoded with a datagram, packet, frame, segment, protocol data unit (PDU), or message as described in or related to any of examples 1-25, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example Z11 may include a computer program comprising instructions, wherein execution of the program by a processing element is to cause the processing element to carry out the method, techniques, or process as described in or related to any of examples 1-25, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMATime Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. An apparatus for use in a user equipment (UE), wherein the apparatus comprises:
memory to store a received physical sidelink control channel (PSCCH) or a physical sidelink shared channel (PSSCH); and
one or more processors configured to:
identify sidelink resources for a plurality of physical sidelink feedback channel (PSFCH) occasions associated with the PSCCH or PSSCH, wherein the sidelink resources are identified based on mapping information that defines the sidelink resources for respective individual PSFCH occasions of the plurality of PSFCH occasions; and
facilitate transmission, by the UE, of a PSFCH in one or more of the PSFCH occasions using the respective sidelink resources.

22. The apparatus of claim 21, wherein the one or more processors are further configured to identify the mapping information received as part of configuration information for a resource pool.

23. The apparatus of claim 21, wherein the sidelink resources for different PSFCH occasions include different physical resource blocks (PRBs) in a frequency domain.

24. The apparatus of claim 21, wherein the one or more processors are further configured to:
determine that the PSFCH is to be transmitted outside of a channel occupancy time (COT) shared by another device; and
facilitate performance, by the UE based on the determination, of a listen-before-talk (LBT) procedure for the transmission of the PSFCH.

25. The apparatus of claim 21, wherein the sidelink resources for the respective individual PSFCH occasions include a set of resource blocks that are interlaced in a frequency domain.

26. The apparatus of claim 25, wherein a frequency-domain orthogonal cover code (OCC) is applied for the transmission of the PSFCH.

27. The apparatus of claim 25, wherein a PRB-level cyclic shift is applied for the transmission of the PSFCH.

28. The apparatus of claim 21, wherein the sidelink resources includes a set of interlaced resource blocks that are common for PSFCHs of multiple UEs, and one or more dedicated physical resource blocks (PRBs) that are dedicated to the respective individual PSFCH occasion.

29. One or more non-transitory computer-readable media (NTCRM) having instructions, stored thereon, that when executed by one or more processors of a user equipment (UE) configure the UE to:
determine that a sidelink synchronization signal block (S-SSB) qualifies as short control signalling;
perform a Type 2A listen-before-talk (LBT) procedure for the S-SSB based on the determination; and
transmit the S-SSB based on a successful result of the Type 2A LBT procedure.

30. The one or more NTCRM of claim 29, wherein the determination is made based on a determination that the S-SSB has no greater than a 5% duty cycle.

31. The one or more NTCRM of claim 29, wherein the S-SSB includes a sidelink primary synchronization signal (S-PSS), a sidelink secondary synchronization signal (S-SSS), and a sidelink physical broadcast channel (S-PBCH) that are transmitted on resource blocks that are interlaced over a channel bandwidth.

32. The one or more NTCRM of claim 29, wherein to transmit the S-SSB includes to repeat the S-SSB in a frequency domain with a frequency gap between the repetitions.

33. The one or more NTCRM of claim 29, wherein the S-SSB is exempted from an occupied channel bandwidth (OCB) requirement.

34. The one or more NTCRM of claim 29, further comprising receiving configuration information for a S-SSB transmission window that includes a plurality of S-SSB occasions, wherein the S-SSB is transmitted in one or more of the S-SSB occasions.

35. The one or more NTCRM of claim 34, wherein the instructions, when executed, further configure the UE to:
perform a first LBT procedure prior to a first S-SSB occasion of the plurality of S-SSB occasions;
if the LBT procedure is successful, transmit the S-SSB in the first S-SSB occasion and not in remaining S-SSB occasions of the S-SSB transmission window; and
if the first LBT procedure is unsuccessful, perform a second LBT procedure prior to a second S-SSB occasion and transmit the S-SSB in the second S-SSB occasion if the second LBT procedure is successful.

36. A user equipment (UE) comprising:
one or more processors; and
one or more non-transitory computer-readable media (NTCRM) having instructions, stored thereon, that when executed by the one or more processors, configure the UE to:
identify sidelink resources for a physical sidelink feedback channel (PSFCH), wherein the sidelink resources include a set of resource blocks (RBs) that are interlaced in the frequency domain; and
transmit the PSFCH in the identified sidelink resources.

37. The UE of claim 36, wherein the set of RBs is a common set of RBs that is used for PSFCH transmissions by a plurality of UEs, and wherein the identified sidelink resources further include one or more dedicated physical resource blocks (PRBs) that are dedicated to the UE.

38. The UE of claim 36, wherein the instructions, when executed, further configure the UE to apply a frequency-domain orthogonal cover code to the PSFCH transmission.

39. The UE of claim 36, wherein the instructions, when executed, further configure the UE to apply a PRB-level cyclic shift to the PSFCH transmission.

40. The UE of claim 36, wherein the instructions, when executed, further configure the UE to:
determine that the PSFCH is to be transmitted outside of a channel occupancy time (COT) shared by another device; and
perform, based on the determination, a listen-before-talk (LBT) procedure for the transmission of the PSFCH.
